(19) United States
(12) Patent Application Publication
(10) Pub. No.: US 2014/0308067 A1
(43) Pub. Date: Oct. 16, 2014

(54) Bamboo Construction Standardization System and Method

(71) Applicant: Joseph Boudeman, Pacifica, CA (US)

(72) Inventor: Joseph Boudeman, Pacifica, CA (US)

(21) Appl. No.: 14/167,987

(22) Filed: Jan. 29, 2014

Related U.S. Application Data
(60) Provisional application No. 61/758,170, filed on Jan. 29, 2013.

(51) Int. Cl. F16B 7/04; F16B 7/18; F16B 7/00

(52) U.S. Cl. CPC F16B 7/04; F16B 7/00; F16B 7/18
USPC 403/205; 403/396; 403/343; 144/333

(57) ABSTRACT

A system and method of selectively coupling structural elements via at least one of: frictional engagement, chemical bonding, structural attachment techniques and/or other known and/or convenient coupling mechanism and/or methods. In some embodiments, wrapping elements can be introduced to standardize the dimensions of the ends of naturally occurring structural members, such as bamboo, to aid in construction.

### RELATED APPLICATIONS

The present application claims the benefit of priority to prior-filed provisional application Ser. No. 61/758,170, filed Jan. 29, 2013, the entirety of which is hereby incorporated herein by reference.

### FIELD OF THE INVENTION

The present disclosure relates to the field of construction, specifically a bamboo member connection system and method.

### BACKGROUND

Bamboo framing and scaffolding is used frequently in construction. Bamboo is prized for its strength, durability, and sustainability by builders and consumers throughout the world. However, current methods of connecting bamboo members to each other and to other surfaces or devices result in structures of inferior quality.

FIG. 1 depicts an embodiment of a presently known system for connecting bamboo elements. In the embodiment depicted in FIG. 1, a first bamboo member 102 can be coupled with a second bamboo member 104. In the embodiment shown, a distal end 106 of the first bamboo member 102 can be overlapped with a distal end 108 of the second bamboo member 104, and the two members 102 104 can be lashed together with a binding element 110 that can frictionally engage the exterior of the ends 106 108 of bamboo members 102 104. The binding of bamboo members 102 104 in an overlapped configuration does not provide superior stability to the connection.

What is needed is a bamboo member connection system and method of forming connections between two or more bamboo members and between bamboo members and surfaces with superior strength, stability, and durability.

### BRIEF DESCRIPTION OF THE DRAWINGS

FIG. 1 depicts a prior art embodiment of a bamboo member connection.

FIG. 2A depicts one embodiment of a bamboo member connection system and method.

FIG. 2B depicts one embodiment of a coupling device having two apertures.

FIG. 2C depicts an alternate embodiment of a coupling device having multiple apertures.

FIG. 2D depicts yet another embodiment of a coupling device having a bracket configuration.

FIG. 2E depicts an alternate embodiment of a coupling device having a bracket configuration.

FIG. 3A depicts one embodiment of a bamboo member connection system and method.

FIG. 3B depicts an alternate embodiment of the bamboo member connection system and method depicted in FIG. 3A.

FIG. 3C depicts one embodiment of the end of a bamboo member.

FIG. 4 depicts one embodiment of a connection point along a linear portion of a bamboo member connection system.

FIG. 5A depicts a close up view of one embodiment of the connection from FIG. 4 in a disconnected configuration.

FIG. 5B depicts an alternate embodiment of the connection depicted in FIG. 5A.

FIG. 5C depicts yet another embodiment of the connection depicted in FIG. 5A.

FIG. 6 depicts one embodiment of a surface-to-bamboo member connection system.

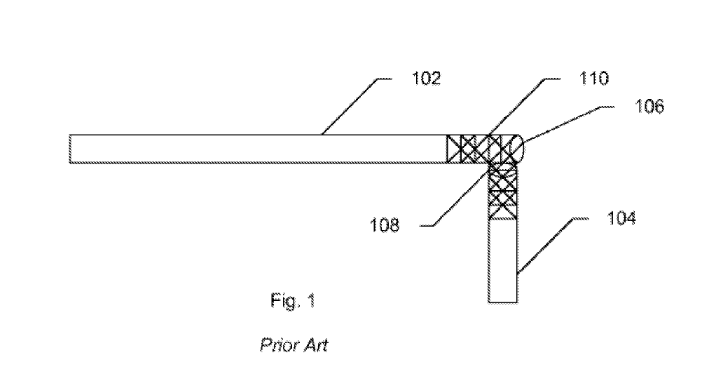

### DETAILED DESCRIPTION

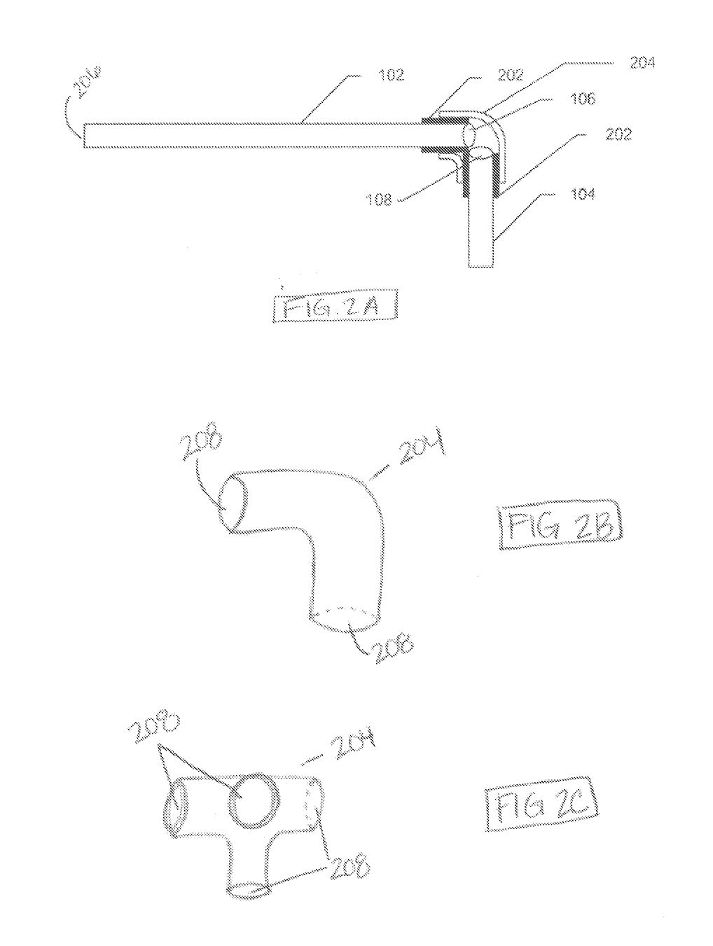

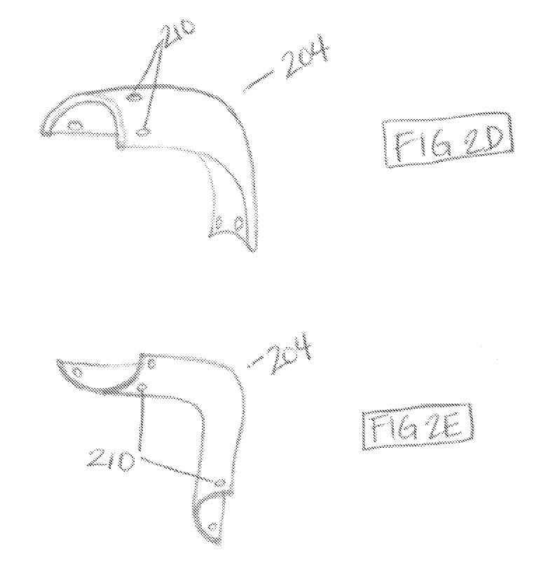

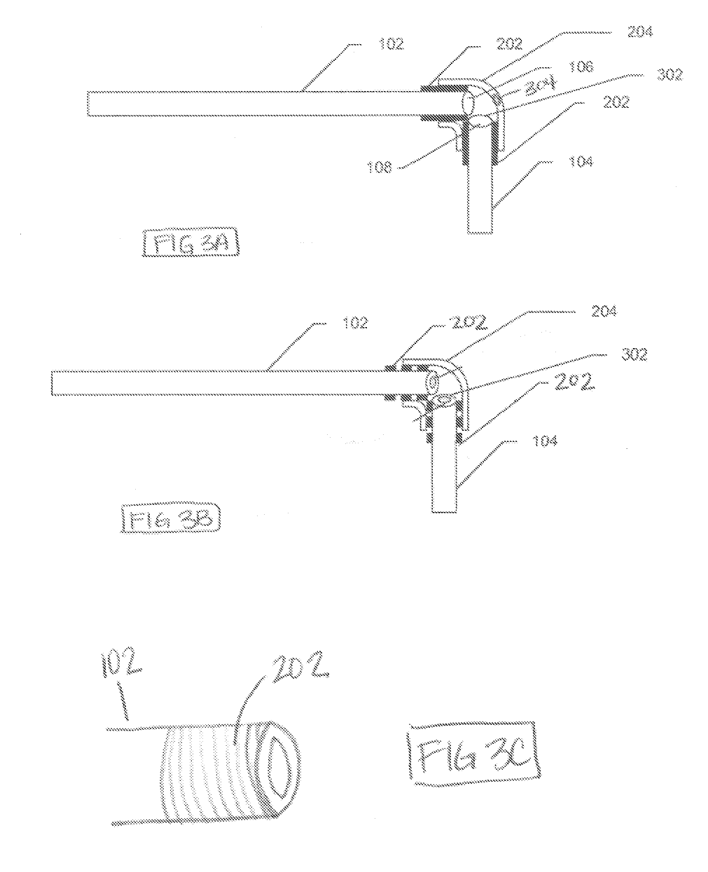

FIG. 2A depicts one embodiment of bamboo member connection system and method. In the embodiment depicted, a system comprises a first bamboo member 102 having a distal end 106, a second bamboo member 104 having a distal end 108, a coupling mechanism 202, and a coupling device 204. First and/or second bamboo members 102 104 can be elongated tubular members. In some embodiments, a first bamboo member 102 and/or a second bamboo member 104 can be at least partially filled with strengthening material 206 to further enhance the strength and durability of the bamboo members 102 104. Strengthening material 206 can be cement, epoxy, polymer, and/or any other known and/or convenient material or combination of materials. In some embodiments, strengthening material 206 can be applied to one or more of bamboo members 102 104 in a liquid form and allowed to solidify. In other embodiments, strengthening material 206 can be solid when applied to bamboo members 102 104. In some embodiments, strengthening material 206 can have expansive properties such that during a curing process the distal ends 106 108 of one or more bamboo members 102 104 can dimensionally increase to better engage a coupling device 204.

A coupling device 204 can be substantially tubular and formed at a substantially right angle, as shown in the embodiment in FIG. 2A. In some embodiments, a coupling device 204 can have two apertures 208 adapted to accept two bamboo members 102 104 (FIG. 2B). In other embodiments, a coupling device 204 can have more than two apertures 208 adapted to accept a plurality of bamboo members (FIG. 2C). As depicted in FIG. 2C, in some embodiments a coupling device 204 can have a T-shaped configuration, however in other embodiments a coupling device 204 can have any other known and/or convenient shape or geometry. Furthermore, in alternate embodiments, a coupling device 204 can have any desired number of apertures 208 of any size or geometry, and the apertures 208 of a coupling device 204 can have differing diameters, geometries, and/or sizes from each other. In the embodiments depicted in FIGS. 2A-2C, the opening diameters of apertures 208 are slightly larger than the outer diameters of the distal ends 106 108 of first and second bamboo members 102 104 to enable proper engagement upon mating. In alternate embodiments, apertures 208 can be configured at any angle relative to each other and such configuration can be dependent on the specific construction need of the project at hand.

Referring to FIGS. 2D-2E, in some embodiments a coupling device 204 can have a bracket configuration. The embodiments depicted show outer (FIG. 2D) and inner (FIG. 2E) curved bracket coupling devices 204 adapted to couple with two bamboo members 102 104 in a right angle configuration. The outer and inner curved brackets 204 can be molded or constructed to conform to the surfaces of the distal ends 106 108 of bamboo members 102 104. In other embodiments, at least one coupling device 204 can be a bracket configured to couple two or more bamboo members at any other known and/or convenient angle or in a linear manner.

In the embodiments depicted in FIGS. 2A-2E, a coupling device 204 can be comprised of polyvinyl chloride material. However, in alternate embodiments, a coupling device 204 can be comprised of plastic, metal, polymer, bamboo, and/or any other desired material or combination of materials. In some embodiments, a coupling device 204 can be comprised of a semi-flexible material for initial assembly of a bamboo member connection system, but the material can then be cured, set, or otherwise hardened in a desired configuration. In further embodiments, the material with which a coupling device 204 is constructed can shrink or constrict post-mating with a bamboo member 102 or 104, either by air exposure, heat exposure, or by any other known and/or convenient mechanism. In some embodiments, the interior surface of a coupling device 204 can be textured or roughened to enable enhanced grip with or frictional engagement of a bamboo member 102 or 104.

As shown in FIGS. 2D-2E, in some embodiments a coupling device 204 can further comprise one or more attachment points 210 for securing to bamboo members 102 104. In the embodiments shown, attachment points 210 can be holes adapted for using with traditional screws, anchor screws, nails, and/or any other desired type of hardware. In other embodiments, attachment points 210 can be areas of pre-applied adhesive or any other desired method for coupling a bamboo member 102 or 104 with a coupling device 204.

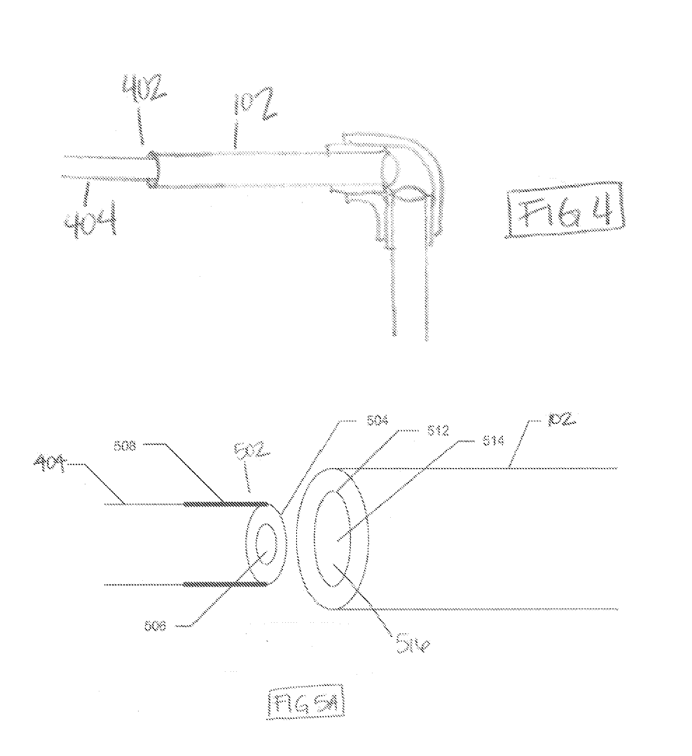

In the embodiment depicted in FIG. 3A, a coupling mechanism 202 can be applied to the distal end 106 of a first bamboo member 102 and/or the distal end 108 of a second bamboo member 104 prior to mating with a coupling device 204. A coupling mechanism 202 can enable a bamboo member 102 or 104 to fixedly or selectively engage with a coupling device 204, either by friction, adhesive, structural bonding, or any other manner of coupling. A coupling mechanism 202 can allow bamboo members of naturally-occurring geometries, sizes, and diameters to couple with a standardized coupling device 204. A coupling mechanism 202 can comprise at least one piece of material that can be wrapped fully around the surface of a bamboo member 102 and/or 104. In other embodiments, a coupling mechanism 202 can comprise a piece of material covering only a portion of the surface of a bamboo member 102 and/or 104. In some embodiments, a coupling mechanism 202 can be a helical wrap (see FIG. 3B) or a wrap applied in any other desired manner or configuration. A coupling mechanism 202 can be comprised of cast tape, polymer mesh, wire mesh, fiberglass, cloth and/or any other known and/or convenient material or combination of materials. In some embodiments, the wrap material can have expansive properties such that it can be applied to the distal end 106 108 of a bamboo member 102 104 and when heat or water are applied, or when the material is exposed to the atmosphere, the wrap material can expand in a desired and/or prescribed manner. In still further embodiments, the material of a coupling mechanism 202 can include an adhesive, bonding agent, or other desired substance, and/or an additional adhesive, bonding agent, expansive material and/or other desired substance can be applied over a coupling mechanism 202.

In additional embodiments and as shown in FIG. 3C, a coupling mechanism 202 can be a threaded portion on the distal end 106 108 of a first and/or second bamboo member 102 104. The threaded portion 202 can be adapted to mate in a screw-like manner with a threaded inner surface of a coupling device 204. In further embodiments, the exterior surface of a bamboo member 102 104 and the interior surface of a coupling device 204 can be configured to complementarily mate with each other, such as by way of complementary longitudinal grooves and ridges, roughened textures, or any other desired surface characteristics that can enable a bamboo member 102 104 to selectively couple with a coupling device 204.

Referring to FIGS. 3A-3B, in some embodiments a bamboo connection system can further comprise introducing a reinforcement material 302 into the space formed between bamboo members 102 104 and a coupling device 204. In the embodiment depicted, reinforcement material 302 can be introduced in a liquid or semi-solid state into the chamber of a coupling device 204 via a fill hole 304. The reinforcement material 302 can then harden by way of air-exposure, heat, or any other desired method. In other embodiments, reinforcement material 302 can be introduced prior to mating bamboo members 102 104 with a coupling device 204. In some embodiments, a coupling device 204 chamber can be pre-loaded with mesh, foam, or other matrix material, such that post-mating with bamboo members 102 104, a coupling device 204 chamber can be filled with reinforcement material 302 and interact with the matrix material to form a material of desired strength. Reinforcement material 302 can be cement, epoxy, polymer, or any other known and/or convenient material or combination of materials with any desired chemical and structural properties.

Referring to FIGS. 2A-3C, in operation a coupling mechanism 202, such as a piece of wrap material, can be applied to the distal end 106 of a first bamboo member 102. Similarly, a coupling mechanism 202 can be applied to the distal end 108 of a second bamboo member 104. Reinforcement material 302 can be introduced into the chamber of a coupling device 204. Distal ends 106 108 of bamboo member 102 104 can then be inserted into apertures 208 of a coupling device 204. Appropriate pressure and/or heat can be applied to solidify, cure, or harden a coupling mechanism 202 and/or reinforcement material 302 or otherwise cause desired coupling of bamboo members 102 104 with a coupling device 204. Proximal ends of bamboo members 102 104 can then be coupled with other coupling devices 204 in a similar manner, or with other bamboo members or surfaces as described below. The preceding describes just one potential in-operation embodiment for the portion of a bamboo connection system portrayed in FIGS. 2A-3C and described herein.

FIG. 4 represents an embodiment of a connection 402 point along a linear portion of a bamboo member connection system. In other embodiments, the connection 402 can be located on a curvilinear or angular portion of a connection system. The distal end of a third bamboo member 404 can be selectively coupled with the proximal end of a first bamboo member 102. In other embodiments, a third bamboo member 404 can be coupled with any other desired bamboo member, a coupling device 204, and/or any convenient element having any chemical, structural, and/or geometric properties.

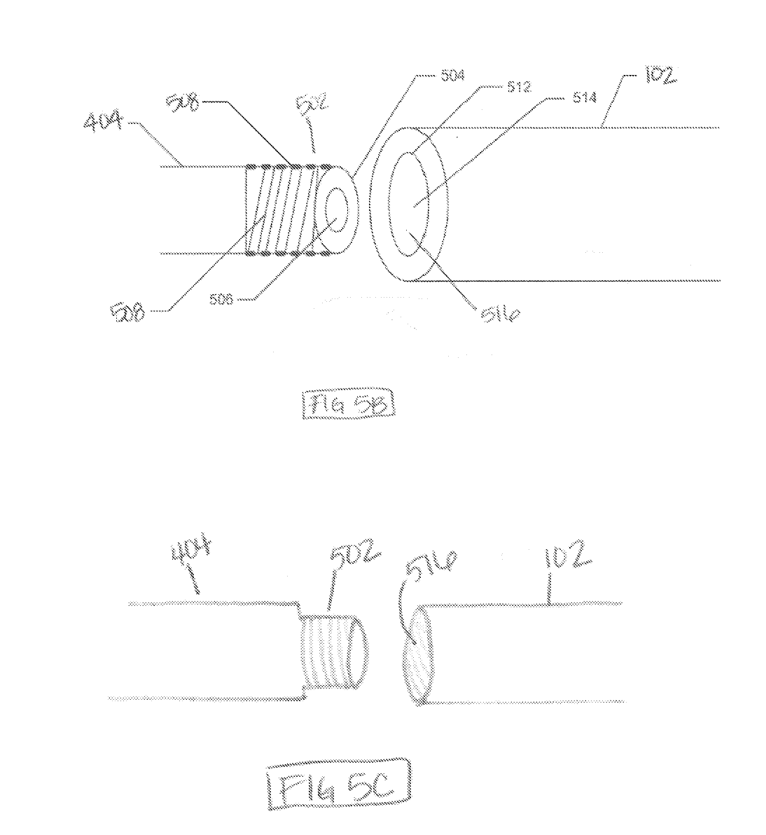

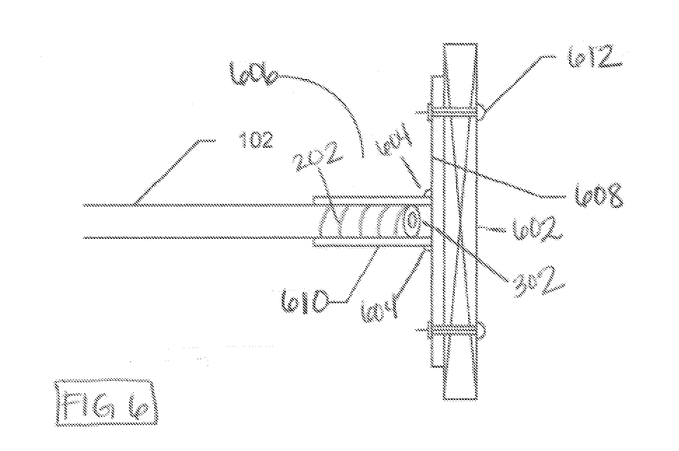

FIG. 5A depicts a close-up view of the connection 402 from FIG. 4 in a disconnected embodiment prior to mating. A third bamboo member 404 can be selected and/or trimmed such that it has an outside diameter 504 less than the inside diameter 512 of a first bamboo member 102. In some embodiments, a coupling mechanism 508 can be applied to the distal end 502 of a third bamboo member 404 prior to mating with a first bamboo member 102 or any other desired element. A coupling mechanism 508 can enable a third bamboo member 404 to fixedly engage with a first bamboo member 102 or any other desired element, either by friction, adhesive, pressure-fit, or any other manner of coupling. A coupling mechanism 508 can comprise at least one piece of material that can be wrapped fully around the surface of a bamboo member 404. In other embodiments, a coupling mechanism 508 can comprise a piece of material covering only a portion of the surface of a bamboo member 404. In some embodiments, a coupling mechanism 508 can be a helical wrap (see FIG. 5B) or a wrap applied in any other desired manner or configuration. A coupling mechanism 508 can be comprised of cast tape, polymer mesh, wire mesh, fiberglass, cloth and/or any other known and/or convenient material or combination of materials. In some embodiments, the wrap material can have expansive properties such that it can be applied to the distal end 502 of a bamboo member 404 and when heat or water are applied, or when the material is exposed to the atmosphere, the wrap material can expand in a desired and/or prescribed manner. In still further embodiments, the material of a coupling mechanism 508 can include an adhesive, bonding agent, or other desired substance, and/or an additional adhesive, bonding agent, expansive material and/or other desired substance can be applied over a coupling mechanism 508.

In additional embodiments and as shown in FIG. 5C, a coupling mechanism 508 can be a threaded portion on the distal end 502 of a third bamboo member 404. The threaded portion 508 can be adapted to mate in a screw-like manner with a threaded inner surface 516 of a first bamboo member 102. In further embodiments, the exterior surface of a third bamboo member 404 and the interior surface of a first bamboo member 102 can be configured to complementarily mate with each other, such as by way of complementary longitudinal grooves and ridges, roughened textures, or any other desired surface characteristics that can enable bamboo members 102 404 to selectively couple with each other. In further embodiments, only the distal end 502 of a third bamboo member 404 can be whittled, shaved, sanded, or otherwise made smaller from its natural state, such that the outer diameter 504 can be less than the inner diameter 512 of a first bamboo member 102, while the remainder of a third bamboo member 404 can remain larger in size than its distal end 502. In some embodiments, this method can result in a connection 402 (see FIG. 4) that is inconspicuous, with the outer diameters of bamboo members 102 404 appearing to be substantially similar.

In the embodiments depicted in FIGS. 5A-5C, the interior chamber 506 of a third bamboo member 404 and/or the interior chamber 514 of a first bamboo member 102 can be at least partially filled with strengthening material 516 to further enhance the strength and durability of the bamboo members 102 404. Strengthening material 516 can be cement, epoxy, polymer, and/or any other known and/or convenient material or combination of materials. In some embodiments, strengthening material 516 can be applied to one or more of bamboo members 102 and/or 404 in a liquid form and allowed to solidify. In other embodiments, strengthening material 516 can be solid when applied to bamboo members 102 and/or 404. In some embodiments, strengthening material 516 can have expansive properties such that during a curing process the distal end 502 of a third bamboo member 404 can dimensionally increase to better engage a first bamboo member 102.

Referring to FIGS. 4-5C, in operation the distal end 502 of a third bamboo member 404 can be altered or configured such that its outer diameter 504 is less than the inner diameter 512 of a first bamboo member 102. A coupling mechanism 508 can then be applied to the distal end 502 of a third bamboo member 404, followed by application of strengthening material 516 to the interior chambers 506 514 of bamboo members 404 102. Bamboo member 404 can then be inserted into bamboo member 102 and appropriate pressure, heat or movement can be applied to fixedly couple bamboo members 404 102. The preceding describes just one potential in-operation embodiment for the portion of a bamboo connection system portrayed in FIGS. 4-5C and described herein.

Referring to FIG. 6, a bamboo member connection system can further comprise a surface-to-bamboo member attachment mechanism 606. In some embodiments, an attachment mechanism 606 can comprise a surface attachment member 608 and one or more receptacles 610. A surface attachment member 608 can be a substantially planar member and can be coupled with a linear surface 602 in a selective manner during the construction process, allowing for precise and proper placement of an attachment mechanism 606 on a surface 602. In other embodiments, a surface attachment member 608 can be adapted to mate with a curvilinear or angular surface 602. One or more receptacles 610 can be fixedly and/or selectively coupled with a surface attachment member 608, and receptacles 610 can be configured to selectively couple with one or more bamboo members 102. In the embodiment depicted, a receptacle attachment mechanism 604 can be employed to fixedly or selectively couple a receptacle 610 to a surface attachment member 608. A receptacle attachment mechanism 604 can be chemical or heat bonding, adhesive or other bonding agent, brackets, screws, or other physical attachment device, and/or any other desired method of attaching a receptacle 610 to a surface attachment member 608.

In the embodiment depicted in FIG. 6, a bamboo member 102 can have a coupling mechanism 202 at its distal end 106. The coupling mechanism 202 can allow the bamboo member 102 to couple with a substantially tubular receptacle 610 in a manner similar to that described above with respect to FIGS. 2A-3C, 4-5C, or any other desired manner of coupling. A coupling mechanism 202 can be a wrap material applied in any convenient configuration, complimentary threaded surfaces on a bamboo member 102 and a receptacle 610, or any other method of coupling. In some embodiments, an adhesive, bonding agent, or expansive material can be applied as a component of or in addition to a coupling mechanism 202. In further embodiments, an adhesive, bonding agent, epoxy, cement, or any other desired reinforcement material 302 can be applied to the interior of a receptacle 610 such that when a bamboo member 102 is inserted, the material 302 can provide additional reinforcement, strength, and/or adhesion. In some embodiments, the interior surface of a receptacle 610 can be textured or roughened to enable enhanced grip with or frictional engagement of a bamboo member 102.

A surface attachment member 608 can be selectively coupled with a surface 602 via at least one surface attachment mechanism 612. In the embodiment depicted, surface attachment mechanisms 612 can be nuts and bolts that can join a surface 602 with a surface attachment member 608. In other embodiments, a surface attachment mechanism 612 can be chemical or heat bonding, adhesive or other bonding agent, brackets, screws, or other physical attachment device, and/or any other desired device and/or method for fixedly and/or selectively attaching a surface attachment member 608 to a surface 602.

Although the receptacle 610 depicted in the embodiment in FIG. 6 is tubular and orthogonal to a surface attachment member 608, in other embodiments a receptacle 610 can have any other desired geometry and can be angled or can otherwise have any other desired spatial configuration with respect to a surface attachment member 608. In some embodiments, a receptacle 610 can be molded or formed specifically to fit a particular bamboo member 102. In other embodiments, a receptacle 610 can be adapted to accept bamboo members of a wide variety of sizes and geometries. In some embodiments, a surface attachment member 608, one or more receptacles 610, and/or one or more surface attachment mechanisms 612 can be separate from each other and then individually coupled with each other as needed. In other embodiments, a surface attachment member 608, one or more receptacles 610, and/or one or more surface attachment mechanisms 612 can be coupled with each other as one unit prior to use in construction.

A surface attachment member 608, one or more receptacles 610, and/or one or more surface attachment mechanisms 612 can be comprised of polyvinyl chloride material. However, in alternate embodiments, a surface attachment member 608, one or more receptacles 610, and/or one or more surface attachment mechanisms 612 can be comprised of plastic, metal, polymer, bamboo, and/or any other desired material or combination of materials. In some embodiments, a surface attachment member 608, one or more receptacles 610, and/or one or more surface attachment mechanisms 612 can be comprised of a semi-flexible material for initial assembly of a bamboo member connection system, but the material can then be cured, set, or otherwise hardened in a desired configuration. In further embodiments, the material with which a surface attachment member 608, one or more receptacles 610, and/or one or more surface attachment mechanisms 612 is constructed can shrink or constrict post-mating with a bamboo member 102, either by air exposure, heat exposure, or by any other known and/or convenient mechanism.

In operation, a receptacle 610 can be secured to a surface attachment member 608 via a receptacle attachment mechanism 604. A surface attachment member 608 can then be secured to a surface 602 via one or more surface attachment mechanisms 612. A coupling mechanism 202 can then be applied to a bamboo member 102, and reinforcement material 302 can be applied to the interior of a receptacle 610. A bamboo member 102 can then be inserted into a receptacle 610 such that the two can be fixedly coupled together. If required, a heat source can be applied to cure and harden a coupling mechanism 202 and/or reinforcement material 302. The proximal end of a bamboo member 102 can then be coupled with a coupling device 204 (see one embodiment depicted in FIG. 2), another bamboo member 104 or 404 (see embodiments depicted in FIG. 4, 5A-5C), or another surface-to-bamboo member attachment mechanism 606. The preceding describes just one potential in-operation embodiment for the portion of a bamboo connection system portrayed in FIG. 6 and described herein.

Although the method has been described in conjunction with specific embodiments thereof, it is evident that many alternatives, modifications and variations will be apparent to those skilled in the art. Accordingly, the method as described and hereinafter claimed is intended to embrace all such alternatives, modifications and variations that fall within the spirit and broad scope of the appended claims.

What is claimed is:

1. A bamboo member connection system, comprising:
a first bamboo member having a distal end and a proximal end;
a second bamboo member having a distal end and a proximal end;
the distal ends of said first and second bamboo members being selectively coupled with each other via at least one coupling device; and
the distal end of at least one of said first and second bamboo members being selectively coupled with said at least one coupling device via at least one coupling mechanism.

2. The bamboo member connection system of claim 1, wherein at least one of said first and second bamboo members is filled with a strengthening material.

3. The bamboo member connection system of claim 1, wherein said at least one coupling device is a substantially tubular member having at least two apertures that can selectively couple with the distal ends of said first and second bamboo members.

4. The bamboo member connection system of claim 1, wherein said at least one coupling device is a curved bracket that can selectively couple with the distal ends of said first and second bamboo members.

5. The bamboo member connection system of claim 1, wherein said at least one coupling mechanism is a piece of material for wrapping around at least a portion of the distal end of at least one of said first and second bamboo members.

6. The bamboo member connection system of claim 5, wherein said coupling mechanism is at least partially comprised of a substance chosen from the group consisting of: cast tape, polymer mesh, wire mesh, fiberglass, and fabric.

7. The bamboo member connection system of claim 1, wherein said at least one coupling mechanism is a threaded surface on the distal end of at least one of said first and second bamboo members that can selectively couple with a complementary threaded surface on said at least one coupling device.

8. The bamboo member connection system of claim 1, wherein said first and second bamboo members are frictionally engaged with said coupling device.

9. The bamboo member connection system of claim 1, further comprising reinforcement material coupled with said at least one coupling device and the distal ends of said first and second bamboo members.

10. The bamboo member connection system of claim 1, further comprising:
a third bamboo member having a distal end and a proximal end; and
said distal end of said third bamboo member being selectively coupled with the proximal end of one of said first and second bamboo members via an additional coupling mechanism.

11. The bamboo member connection system of claim 10, wherein said additional coupling mechanism is a piece of material for wrapping at least a portion of at least one end of at least one of said first, second, and third bamboo members.

12. The bamboo member connection system of claim 1, further comprising:
a substantially planar member coupled with at least one tubular receptacle in an orthogonal configuration;
said substantially planar member being coupled with a surface via a surface attachment mechanism;
said at least one tubular receptacle being coupled with the proximal end of said first bamboo member.

13. A method for connecting bamboo members, comprising the steps of:
obtaining first and second bamboo members of appropriate size and length;
applying reinforcement material to at least a portion of the interior of a coupling device;
applying at least one coupling mechanism to the distal ends of said first and second bamboo members;
inserting the distal end of a first bamboo member into a first aperture of said coupling device; and
inserting the distal end of a second bamboo member into a second aperture of said coupling device.
